(19) United States
(12) Patent Application Publication
(10) Pub. No.: US 2015/0120358 A1
(43) Pub. Date: Apr. 30, 2015

(54) Customer Loyalty Retention Tracking System and Method

(71) Applicant: DropThought,Inc, Santa Clara, CA (US)

(72) Inventor: Karan Chaudhry, Palo Alto, CA (US)

(21) Appl. No.: 14/526,390

(22) Filed: Oct. 28, 2014

Related U.S. Application Data
(60) Provisional application No. 61/896,633, filed on Oct. 28, 2013.

(51) Int. Cl. G06Q 10/06; G06Q 30/00

(52) U.S. Cl. CPC G06Q 10/063114; G06Q 10/06393; G06Q 30/016
USPC 705/7.15

(57) ABSTRACT

A computer-implemented method for customer loyalty retention tracking is provided. The method comprises receiving a plurality of feedback messages via at least one customer feedback interface; classifying the plurality of feedback messages into at least one category comprising negative feedback messages being message with negative feedback; for each negative feedback message, tracking when a manager sends a response message to said feedback message; and if said response message was sent then sending an evaluation message to evaluate and effectiveness of said response message; and computing a Net Promoter Score (NPS)-like based on responses to evaluation messages.

### PRIORITY

This application claims the benefit of priority to U.S. No. 61/896,633 filed on Oct. 28, 2013 and entitled “CUSTOMER LOYALTY RETENTION TRACKING SYSTEM AND METHOD”.

### BACKGROUND

When customers' needs and expectations are not met by a business, a customer may leave feedback of a negative nature. How a business responds to the negative feedback may have a material impact on the ability of the business to retain the customer on a long-term basis.

### WRITTEN DESCRIPTION

Broadly, embodiments of the invention disclose techniques and systems to gauge how effective a business is at responding to negative feedback left by its customers.

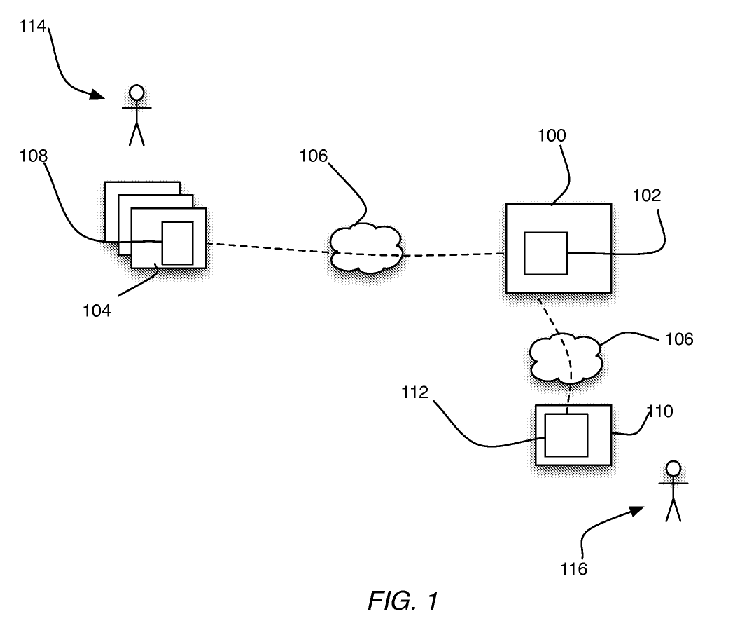

FIG. 1 of the drawings shows a deployment scenario for one embodiment of the invention. Referring to FIG. 1, a server 100 includes a Feedback Tracking and Monitoring Application (FTMA) 102. In one embodiment, the Feedback Tracking and Monitoring Application (FTMA) 102 supports communications with a plurality of Customer Feedback Interfaces 104. Said communications may be facilitated by a network 106, which may include wired and wireless networks. In one embodiment, the network 106 may support packet-based communications and may include the Internet.

The Customer Feedback Interfaces 104 may include client devices such as smart phones, tablet computers, etc. provisioned with a custom application for managing customer feedback. In some embodiments, the Customer Feedback Input Interfaces 104 may include a web interface to the Feedback Tracking and Monitoring Application (FTMA) 102.

In a typical use case, client feedback interface 104 may include a mobile phone provisioned with an application 106 whereby feedback may be sent to the Feedback Tracking and Monitoring Application (FTMA) 102, as will be described.

A Manager Interface 108 may comprise a mobile phone provisioned with a manager application 110. The Manager Interface 108 may be communicatively coupled with the Feedback Tracking and Monitoring Application (FTMA) 102 via the network 106.

To begin a typical use case, a customer 114, leaves feedback of a negative nature using the application 104.

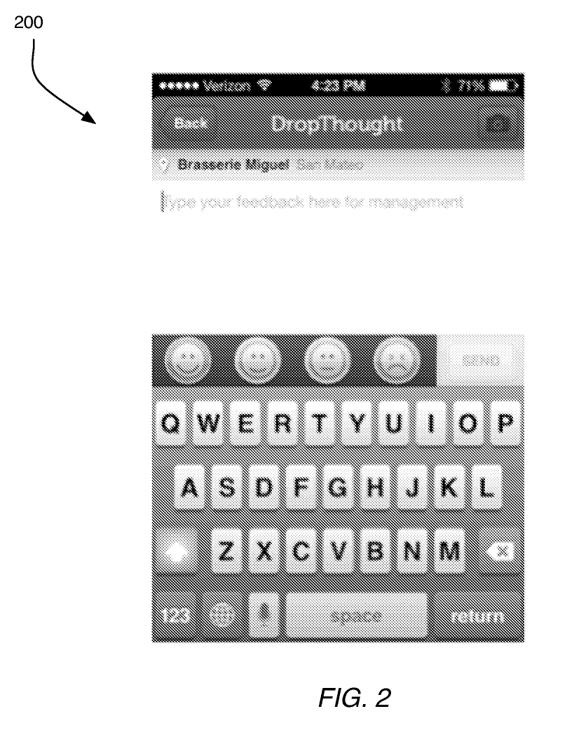

FIG. 2 shows user interface (UI) 200 that may be used to input the negative feedback. Once the feedback is input, it is transmitted to the FTMA 102 via the communications medium 106. A manager 116 is notified of the feedback via the manager application 112.

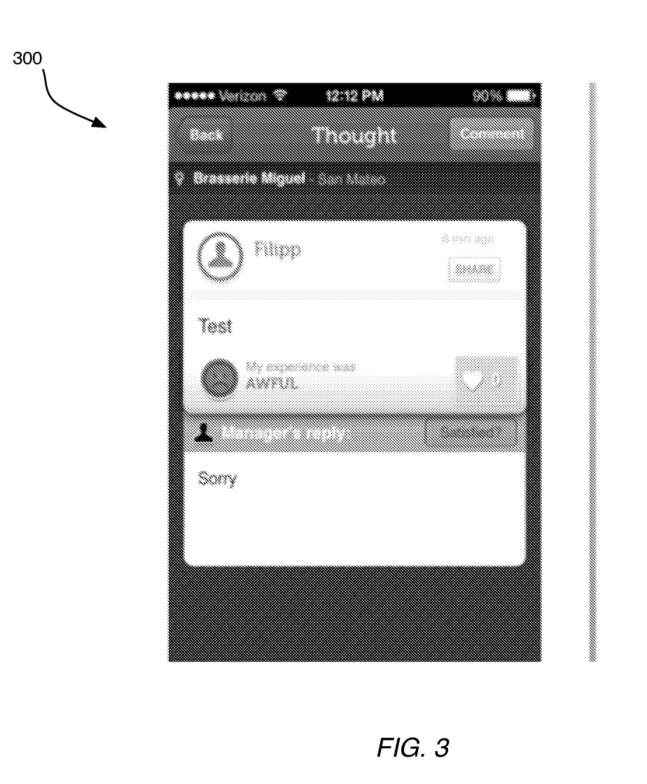

In response to said notification, the manager 116 may perform an action in relation to the negative feedback. For example, the manager 116 may reply to the feedback by transmitting an apology message to the customer 114. FIG. 3 of the drawings shows a user interface 300 of the application 104 wherein the negative feedback, and the manager's reply thereto can be seen.

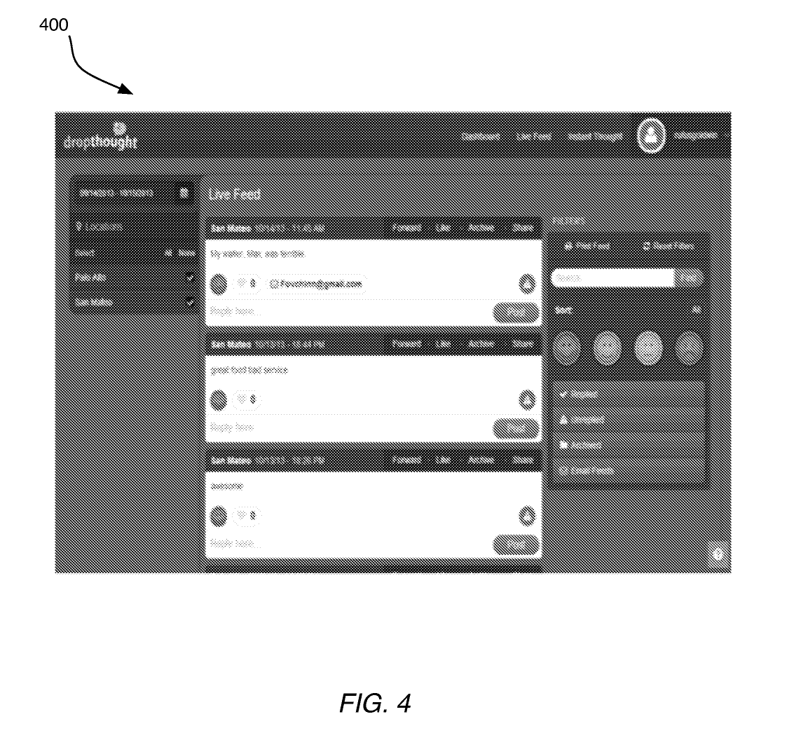

In one embodiment, the FTMA 102 provides a live feed to the manager 116 of all feedback received from customers associated with a plurality of locations/business establishments for which the manager 116 is responsible. FIG. 4 of the drawings shows a user interface 400 with the live feed. As can be seen from FIG. 4, the FTMA 102 allows the manager 116 to apply one or more filters to filter messages received from the customers. For example, a filter may be applied to filter messages that are classified accordingly to the nature of the feedback. Examples of classifications includes awful, good, poor, etc. In one embodiment a color coding scheme may be used to indicate the nature of a message. For example, the color red which signifies danger may be used in association with the messages that are classified as particularly bad, whereas the color green may be associated with the messages are classified as particularly of a positive nature.

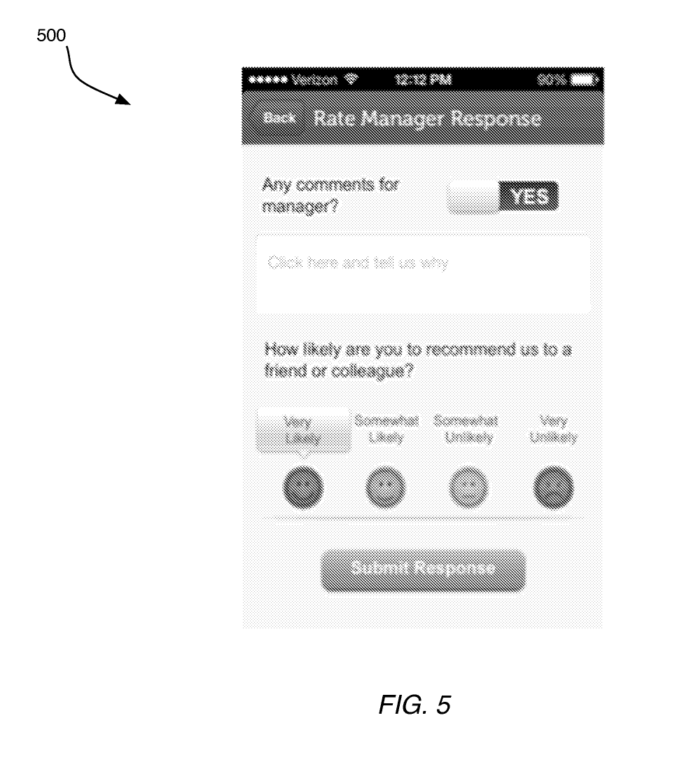

In one embodiment, the FTMA 102 may be configured to determine when a manager 116 has responded to a message and may use this condition as a trigger to generate an evaluation message for a customer. FIG. 5 of the drawings shows an example of an evaluation message 500 where a customer is asked to provide comments for a manager. The evaluation message 500 also asks the customer the question “How likely are you to recommend us to friend or colleague”. Responses to the evaluation messages are captured by FTMA 102 and classified in a manner that indicates a likelihood of whether the customer will be retained or not.

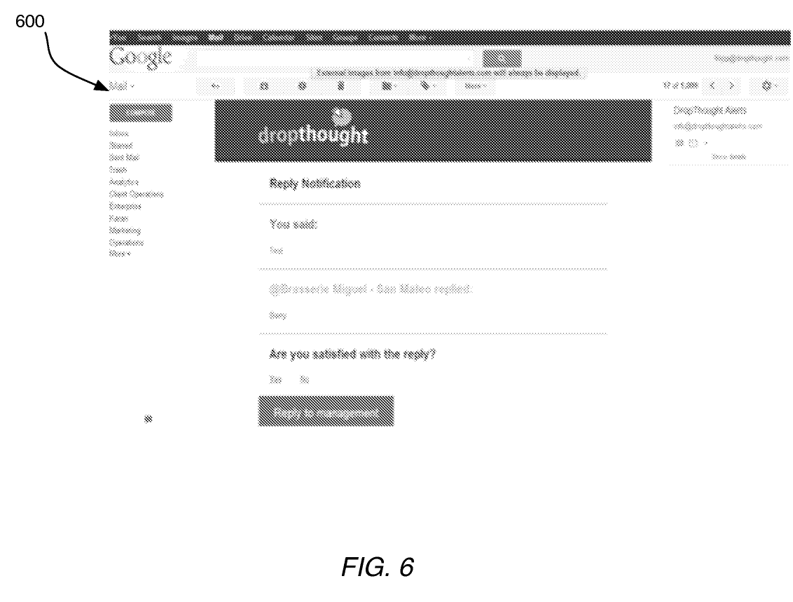

FIG. 6 shows another example of an evaluation message 600 which is transmitted via email to a customer. In the evaluation message 600, the customer is simply asked whether he/she is satisfied with the manager's reply.

Embodiments of the present invention include classifying all responses to evaluation messages into categories that indicate a likelihood of whether a customer will be retained or not. In some embodiments, a Net Promoter Score (NPS)-like score may be computed based on responses to evaluation messages.

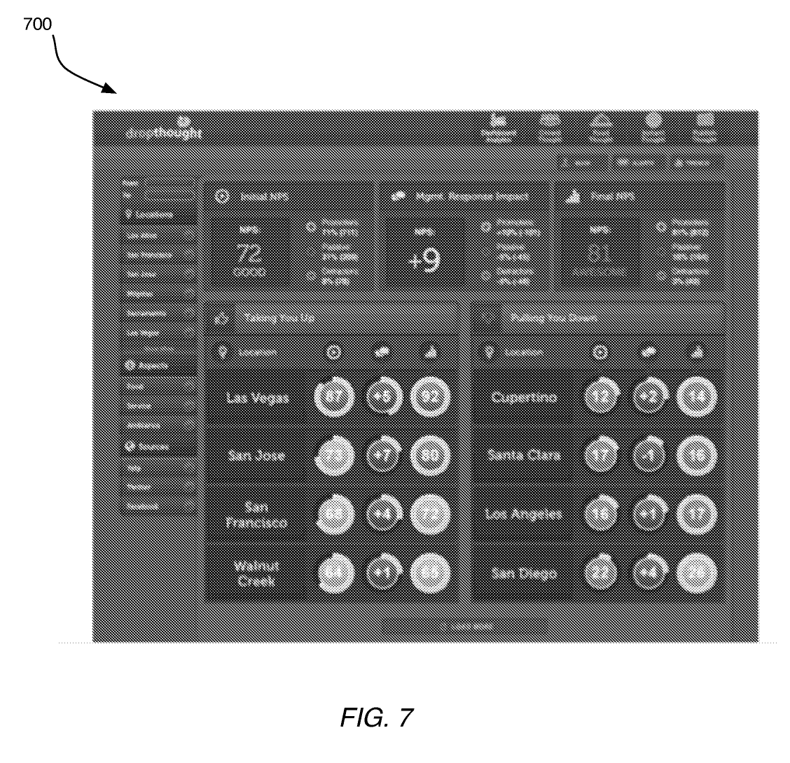

Conveniently, in one embodiment, the NPS score may be presented in the form of the dashboard 700 as is shown in FIG. 7 of the drawings. As can be seen from FIG. 7, that dashboard 700 shows that initially the business had an NPS score of 72. Responsive to the manager's handling of the negative feedback, the NPS score increased by 9 to produce a NPS score of 81. Thus, the techniques disclosed herein may be used to quantify the effectiveness of manager's actions in relation to negative feedback.

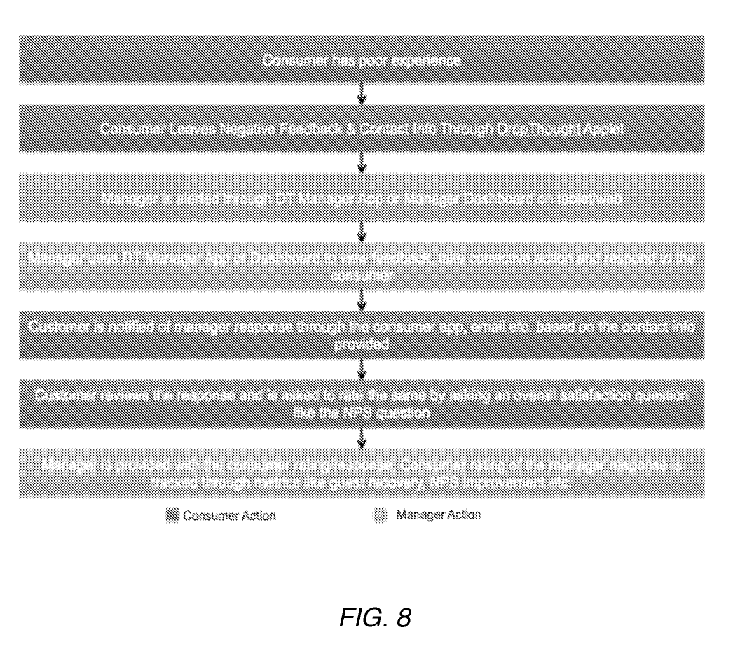

FIG. 8 of the drawings shows a flowchart of the entire end-to-end flow for loyalty tracking/customer retention, in accordance with one embodiment.

In one embodiment, the FTMA 102 may be implemented as software and as such may include computer readable media which when executed by a processing system causes said system to perform a method for customer loyalty retention tracking as described herein.

1. A computer-implemented method, comprising:
receiving a plurality of feedback messages via at least one customer feedback interface;
classifying the plurality of feedback messages into at least one category comprising negative feedback messages being messages with negative feedback;
for each negative feedback message, tracking when a manager sends a response message to said feedback message; and if said response message was sent then sending an evaluation message to evaluate and effectiveness of said response message; and
computing a Net Promoter Score (NPS)-like based on responses to evaluation messages.
